(19) United States
(12) Patent Application Publication
(10) Pub. No.: US 2025/0370671 A1
(43) Pub. Date: Dec. 4, 2025

(54) METHODS AND PRINTING SYSTEM MANAGING OUT OF SEQUENCE RENDERING FOR PRINTING OPERATIONS

(71) Applicant: Kyocera Document Solutions Inc., Osaka (JP)

(72) Inventors: Jayant BHATT, Torrance, CA (US); Javier A. MORALES, Rochester, NY (US); Neil-Paul Payoyo BERMUNDO, Glendora, CA (US)

(73) Assignee: Kyocera Document Solutions Inc., Osaka (JP)

(21) Appl. No.: 18/675,950

(22) Filed: May 28, 2024

(51) Int. Cl. G06F 3/12

(52) U.S. Cl. CPC G06F 3/1234; G06F 3/1208

(57) ABSTRACT

A printing system includes a printing device that receives print jobs. The printing device includes a controller having a raster image processing (RIP) system includes a RIP manager and at least one renderer. The RIP system renders a page of a plurality of pages. After the page is printed, a defect is detected on the page. The engine manager detects that the page is not available in the storage for rendered pages. The RIP manager is instructed to re-render the page using a renderer assigned to perform out of sequence rendering to render the page for printing.

### FIELD OF THE INVENTION

The present invention relates to a printing system and associated methods to render one or more pages of a print job out of sequence.

### DESCRIPTION OF THE RELATED ART

For a print job, the pages of a job are first rendered and then sent for printing within a printing device. After the last copy of a page is submitted to the print engine of the printing device, the page is deleted to make space. Under certain circumstances, a page can be deleted from a storage before it is printed, or before the last copy is submitted to the print engine. If the print engine requires a page that has been deleted, then the page has to be rendered again, which causes out of sequence rendering of pages.

Multiple jobs may be active at the same time. The deleted pages can either belong to a job that is still rendering other pages, or belong to a job that has completed rendering. The resources required for rendering out of sequence pages might be occupied with other pages or other jobs, and has to be made available to process out of sequence pages. This “out of sequence” rendering disrupts the normal printing flow during printing operations.

### SUMMARY OF THE INVENTION

A method for managing printing operations is disclosed. The method includes processing a print job at a raster image processing (RIP) system corresponding to a printing device. The print job includes a plurality of copies of a document having at least one page. The method also includes rendering a page of a first copy of the plurality of copies using the RIP system. The method also includes storing the page of the first copy within a storage associated with the RIP system. The method also includes determining a storage threshold for the storage associated with the RIP system is reached. The method also includes deleting the page after the first copy is printed from the storage. The method also includes detecting that the page from the first copy is not available within the storage for printing a subsequent copy of the document. The method also includes instructing a RIP manager of the RIP system to render the page. The method also includes assigning a RIP to the page. The method also includes rendering the page at the assigned RIP to print with the subsequent copy.

A method for managing printing operations is disclosed. The method includes processing a print job at a raster image processing (RIP) system corresponding to a printing device. The print job includes a plurality of copies of a document having at least one page. The method also includes rendering a page of the first copy of the plurality of copies using the RIP system. The method also includes storing the page of the first copy within a directory file associated with the RIP system. The method also includes determining a directory file limit threshold for the directory file associated with the RIP system is reached. The method also includes deleting the page after the first copy is printed from the directory file. The method also includes detecting that the page from the first copy is not available within the directory file for printing a subsequent copy of the document. The method also includes instructing a RIP manager of the RIP system to render the page. The method also includes assigning a RIP to the page. The method also includes rendering the page at the assigned RIP to print with the subsequent copy.

A method for managing printing operations is disclosed. The method includes processing a print job at a raster image processing (RIP) system corresponding to a printing device. The print job includes a plurality of pages. The method also includes rendering a first page of the plurality of pages using the RIP system. The method also includes determining a storage threshold for a storage associated with the RIP system is reached. The method also includes determining that the first page is a simple page for processing within the RIP system. The method also includes deleting the first page from the storage associated with the RIP system. The method also includes detecting that the first page is not available within the storage for printing. The method also includes instructing a RIP manager of the RIP system to render the first page. The method also includes assigning a RIP of the RIP system to the first page. The method also includes rendering the first page at the assigned RIP for printing with the plurality of pages.

A method for managing printing operations is disclosed. The method includes processing a print job at a raster image processing (RIP) system corresponding to a printing device. The print job includes at least one page. The method also includes rendering a page of the at least one page for the print job using the RIP system. The method also includes printing the page at the printing device. The method also includes deleting the page from a storage associated with the RIP system. The method also includes detecting an error on the page as printed. The method also includes detecting that the page is not available within the storage for reprinting. The method also includes instructing a RIP manager of the RIP system to render the page. The method also includes assigning a RIP of the RIP system to the page. The method also includes rendering the page at the assigned RIP for reprinting.

A method for managing printing operations is disclosed. The method includes processing a print job at a raster image processing (RIP) system corresponding to a printing device. The print job includes a plurality of copies of a document having at least one page. The method also includes rendering a page of a first copy of the plurality of copies using the RIP system. The method also includes detecting that the page from the first copy is not available for printing a subsequent copy of the document. The method also includes instructing a RIP manager of the RIP system to render the page. The method also includes assigning a RIP to the page. The method also includes rendering the page at the assigned RIP to print with the subsequent copy.

A printing device is disclosed. The printing device includes a print engine to perform printing operations. The printing device also includes a digital front end (DFE) having a processor and a memory. The DFE manages the printing operations in conjunction with the print engine. The memory stores instructions that, when executed on the processor, configures the processor to perform the operations of processing a print job at a raster image processing (RIP) system corresponding to the DFE. The print job includes a plurality of copies of a document having at least one page. The operations further include rendering a page of a first copy of the plurality of copies using the RIP system. The operations further include detecting that the page from the first copy is not available for printing a subsequent copy of the document. The operations further include instructing a RIP manager of the RIP system to render the page. The operations further include assigning a RIP to the page. The operations further include rendering the page at the assigned RIP to print with the subsequent copy.

### BRIEF DESCRIPTION OF THE DRAWINGS

Various other features and attendant advantages of the present invention will be more fully appreciated when considered in conjunction with the accompanying drawings.

FIG. 1 illustrates a printing system for managing jobs according to the disclosed embodiments.

FIG. 2 illustrates a block diagram of components of the printing device for use within the printing system according to the disclosed embodiments.

FIG. 3 illustrates a block diagram of a RIP system for use in processing a job in the printing system according to the disclosed embodiments.

FIG. 4 illustrates a block diagram of an example RIP used within the RIP system according to the disclosed embodiments.

FIG. 5 illustrates a block diagram of the RIP system for use in managing printing operations according to the disclosed embodiments.

FIG. 6 illustrates a flow diagram for managing printing operations during out of sequence rendering process according to the disclosed embodiments.

FIG. 7 illustrates another flow diagram for managing printing operations according to the disclosed embodiments.

FIG. 8 illustrates another flow diagram for managing printing operations according to the disclosed embodiments.

FIG. 9 illustrates a flow diagram for page complexity determination in the RIP system according to the disclosed embodiments.

FIG. 10 illustrates a block diagram of the components used for page complexity determination according to the disclosed embodiments.

FIG. 11 illustrates another flow diagram for managing printing operations (defect detection) according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

A print job may be composed of a variety of pages. Some of the pages may be simple and rendered at a higher speed compared to the engine speed. Other pages may be complex and take a long time to render. Further, the type of job sent for processing may vary from one job to another. Some of the jobs are required to be printed immediately, while other jobs are only rendered and printed at a later time, or process and hold jobs. Other jobs only may print one copy and hold the remaining copies to be printed on user demand, or a proof and hold job. Other jobs may require multiple copies to be printed. Depending on the type of job, and the difficulty of pages in a job, management of printing operations results in time and storage/space complexity.

The disclosed embodiments provide a RIP system that uses a hybrid I/O, with some pages rendering to memory and other pages rendering into disk storage. Disk storage may refer to high capacity storage drive of a hierarchy of storage drives. Several embodiments may be implemented. In one embodiment, the job pages are processed serially. The pages are rendered into an allocated portion of the host's memory, or the memory of a RIP system or controller of the host printing device.

Rendered pages accrue in the host memory as they are rendered. The pages are deleted as they are sent to the printing device. When there is no additional memory, the disclosed embodiments will store rendered pages in disk storage as this contains a larger capacity than the memory. As pages print and space becomes available, the disclosed embodiments will automatically switch back to storing pages in memory. The disclosed embodiments may alternate between rendering in memory and disk storage based on available space.

The disclosed embodiments manage rendered pages based on storage availability. This feature ensures that rendering of a page is available on demand, especially if outside the normal sequence of rendering. For example, some use cases may be defined when out of sequence rendering of a page is required. A page may be deleted after the first copy is printed for a multi-copy collated job, including “proof and hold” jobs. This situation may occur when a critical space threshold limit is reached while printing a long job. It also may occur when a directory file threshold limit is reached while printing a long job. There are restrictions on the number of entries that can be stored in a directory for different file allocation table. If the number of entries exceed that restriction, then a failure may occur.

Other use cases include that simple pages are deleted and complex pages are retained after rendering when a critical space threshold limit is reached. A simple page may be one that can be rendered at engine speed of the print engine. Other cases also include when the print engine wants a page re-rendered, such as when a white line is detected on a printed page. The printed page may be deleted as the document has been printed, as per normal printing operations.

A RIP system may include a RIP manager and an engine manager. When an engine manager notices that a rendered page is missing, it sends a message to the RIP manager for re-rendering. The engine manager then waits for an acknowledgement message from the RIP manager. The RIP manager manages the renderers, and provides a free renderer to re-render the requested page. If all renderers are busy, then the RIP manager takes away a renderer from an already processing job using various schemes. The RIP manager uses the reassigned renderer to re-render the requested page.

The RIP manager sends a rendered page message back to the engine manager once the re-rendering is completed for the out of sequence page. After the engine manager has consumed the re-rendered page, it sends an acknowledgement back to the RIP manager, and the out of sequence rendering process is complete. Thus, the “out of sequence” rendering of pages does not follow the normal print path for printing operations.

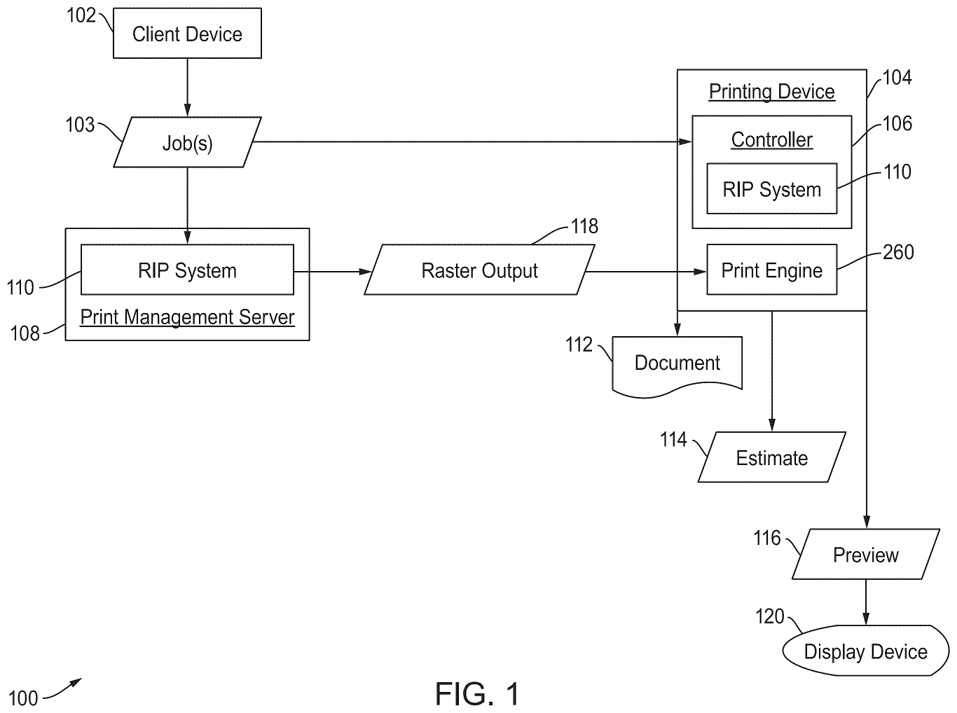

FIG. 1 depicts a printing system 100 for managing jobs using RIP system 110 according to the disclosed embodiments. Printing system 100 may be located in a print shop or other environment suitable for production printing operations. Printing system 100 includes one or more printing devices 104 that receive jobs 103 from one or more client terminals 102.

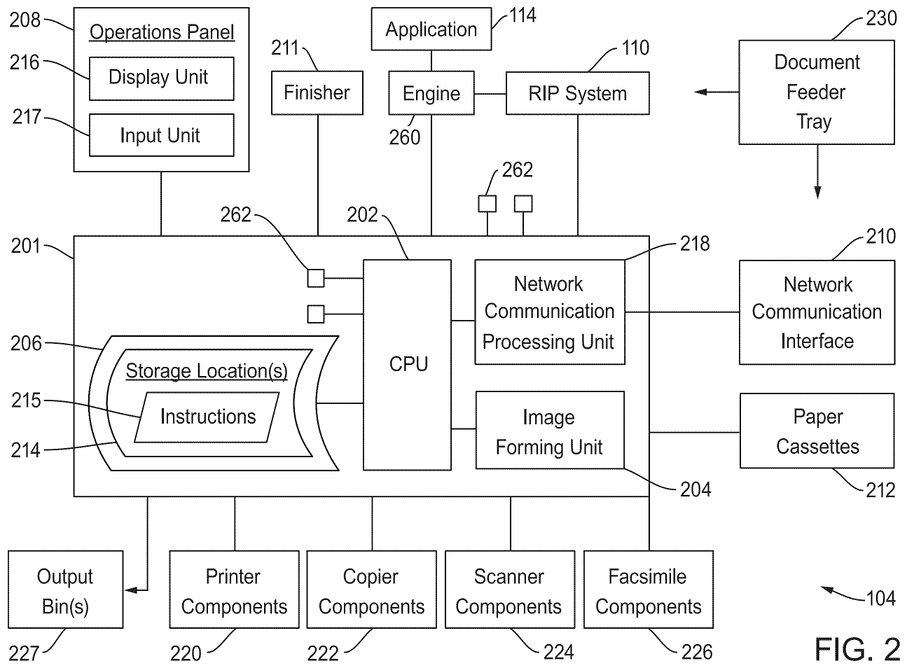

Printing device 104 receives jobs through printing system 100, such as job 103. In some embodiments, job 103 is a print job. After processing job 103, printing device 104 may print or produce document 112 in a paper or media specified by the print job. Printing device 104 is disclosed in greater detail in FIG. 2. Printing device 104 also includes a controller, or digital front end (DFE), 106, which facilitates processing job 103. Controller 106 also includes RIP system 110, which is disclosed in greater detail below.

For example, controller 106 may use RIP system 110 to convert bitmap images, vector graphics, fonts, and the like associated with pages in job 103 to bitmap/rasterized representations of the pages, such as C, M, Y, and K pixels. The sum of the values of pixels of a particular color in the rasterized pages may be proportional to the amount of consumables used by printing device 104 to print that color. RIP system 110 may rasterize pages of job 103 according to various image rasterization settings. For example, these image rasterization parameters may include calibration curves, paper definitions, ICC profiles, spot color definitions, TRCs, color conversion settings, colorant limits for ink or toner, rendering intent, K preservation, CGR level, max colorant densities, print margins, halftones, and the like.

Print engine 260 also is included with printing device 104. Printing device 104 may correspond to an industrial printing device capable of printing thousands of pages in an hour. Printing device 104 may be ink-based, toner-based, or both. Print engine 260 may include various parameters that can control the operation of printing device 104. For example, these settings may include printing device maintenance settings that control or effect head cleaning intervals, head clogging prevention intervals, and the like of printing device 104. Print engine 260 receives raster output from RIP system 110 in printing device 104 to print document 112 based on job 103.

Printing system 100 receive job 103 and may route it directly to printing device 104. Alternatively, printing system 100 may route job 103 to print management server 108. Print management server 108 may seek to offload processing of job 103 from controller 106 of printing device 104. This feature may be desirable if controller 106 does not have the processing capacity to handle jobs 103 in a production printing environment. Thus, print management server 108 also may include RIP system 110 that can provide raster output 118 directly to print engine 260 of printing device 104. These embodiments allow controller 106 to offload processing in order to handle other operations. Further, updates to RIP system 110 may occur at print management server 108 prior to any updates to RIP system 110 in printing device 104.

Job 103 is not always a print job that produces document 112. In some embodiments, job 103 may be an estimation job or a preview job. RIP system 110 determines which type of job is job 103 and configures itself accordingly. For an estimation job, RIP system 110 configures RIPs to process job 103 without impacting print processing within controller 106. The estimation RIPs process job 103 to provide an ink or toner estimate 114. Estimate 114 may be provided to an operator without engaging print engine 260.

For a preview job, RIP system 110 configures RIPs to process job 103 to quickly generate a lower resolution output as preview 116. Preview 116 may be a lower resolution output as compared to document 112 and estimate 114. Preview 116 is provided to the operator to review. Preview 116 may be provided to display device 120 for the operator to review and interact with using an interface. Display device 120 may be a separate device from client device 102 and printing device 104. In other embodiments, display device 120 may be incorporated within client device 102 or printing device 104.

RIP system 110 may be a smart system that enables optimal processing by using page complexity determination to handle a variety of jobs 103. Different jobs received at printing device 104 or print management server 108 result in different output, such as document 112, estimate 114, or preview 116. The RIP instances within RIP system 110 are configured according to the type of job 103 is received.

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within printing system 100. As disclosed above, printing device 104 may send and receive data from client device 102, print management server 108, if a separate device, and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays. Paper cassettes 212 may include papers having various sizes, colors, composition, and the like. Papers or media within paper cassettes 212 may be considered “loaded” onto printing device 104. The information for printing these papers may be captured in a paper catalog stored at controller 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from print management server 108. Display unit 216 may act as display device 120 for displaying preview 116 after it is generated by RIP system 110.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. RIP system 100 that interprets the page description languages (PDLs) would transmit and send instructions down to the lower-level engine 260 for actual rendering of an image and application of the ink onto paper during operations on printing device 104. RIP system 110 may be located in DFE 106, as disclosed above. Alternatively, RIP system 110 may be located on print management server 108 and directly communicates with print engine 260.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device.

Memory unit 206 may store the history of failure events and occurred errors with a timestamp of each error. Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from client device 102 and print management server 108 as well as other printing devices within printing system 100.

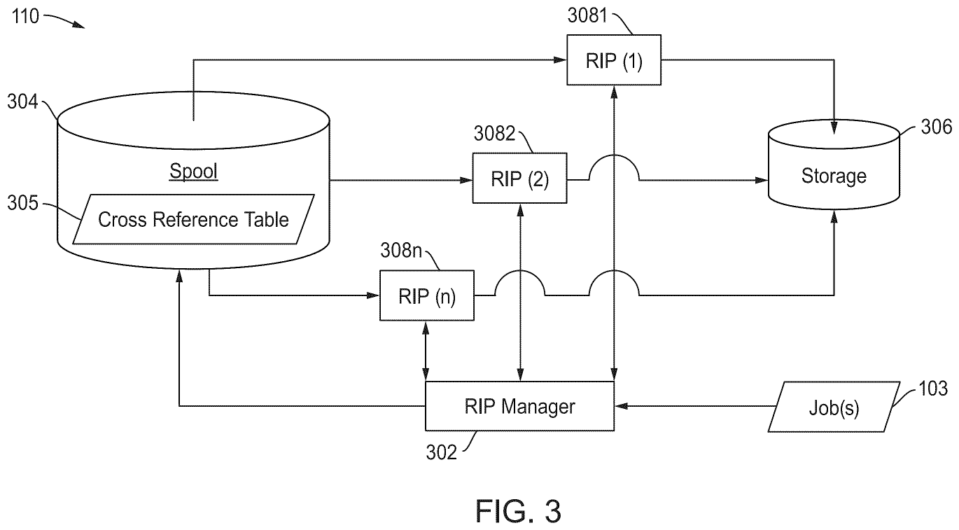

FIG. 3 depicts a block diagram of RIP system 110 for use in processing job 103 in printing system 100 according to the disclosed embodiments. As disclosed above, RIP system 110 may be located in controller 106 of printing device 104. It also may be located on print management server 108 such that it communicates directly with print engine 260 of printing device 104.

RIP system 100 include RIP manager 302 and RIP instances RIP 3081, RIP 3082, and RIP 308n. A RIP instance may be a RIP configured by RIP manager 302 to process job 103. A RIP instance may be a standard RIP, a high performance RIP, a very high performance RIP, a preview RIP, an estimation RIP, or a failover RIP. All RIP instances and RIP manager 302 operate in parallel to each other.

RIP manager 302 performs a variety of operations. It may contain multiple subunits that operate in parallel to perform the variety of operations, like spooling job 103, managing job 103, managing pages or segments of job 103, managing RIP instances 3081, 3082, and 308n, managing drives, determining the PDL type of job 103, distributing pages of segments of job 103 to the RIP instances, serializing pages or segments of job 103, sending notifications within printing device 104 or print management server 108.

RIP manager 302 may receive job 103 through printing system 100. Job 103 may be received from client device 102 via internet protocols within printing system 100. Job 103 may be spooled by RIP manager 302 and stored in spool drive 304. Spool drive 304 may be a configurable drive. RIP manager 302 determines the PDL type of job 103. It then creates a cross reference table 305 in spool drive 304, which acts as a shared memory with RIP instances 3081, 3082, and 308n. RIP manager 302 also may create print ticket information in spool drive 304.

RIP manager 302 analyzes job 103 to determine which type of job it is. It uses this information to determine the number of RIPs and type of RIPs to be used in processing job 103. These features are disclosed in greater detail below. Depending on the type of job, RIP manager 302 configures RIP instances 3081, 3082, and 308n. A configuration operation may create a RIP having a certain number of renderers. For example, RIP instance 3081 may be a standard RIP having a normal number of renderers, such as 4. RIP instance 3082 may be a high performance RIP that has a higher number of renders, such as 6. RIP manager 302 configures the RIP instances accordingly to process job 103.

RIP manager 302 then distributes pages or segments of job 103 to RIP instances 3081, 3082, and 308n. Job 103 may be a print job that is split into segments or pages for parallel processing. As RIP instance 3082 is a high performance RIP, then it may receive specific pages or segments of job 103. Pages may refer to one or more pages of job 103. Segments of job 103 also may refer to a number of pages or a block of data within job 103. The pages or segments are distributed by front end 302 using inter-process communication.

RIP instances 3081, 3082, and 308n may read cross reference table 305 along with print ticket information and the spooled data for job 103. Each RIP instance then processes the page or segment that it is instructed to by RIP manager 302. The RIP instance may check cross reference table 305 to obtain any instructions in the print ticket information and the data for the page or segment in spool drive 304. RIP instances 3081, 3082, and 308n then parse the data for the page or segment to create metadata from the drawing commands.

The RIP instances render the metadata to storage 306. Storage 306 may store the rendered pages for a print job of job 103. The rendered pages may be stored according to a specific image format, such as the KYOCERA™ Image Format (KIF). The stored pages may then be provided to print engine 260 to print document 112. For jobs 103 that do not require rendered pages, such as previews and estimates, the data generated by the RIP instances may be provided back to front end 302 for further operations.

RIP system 110 provides advantages over conventional RIP systems. RIP manager 302 may control the number of renderers per RIP. It may increase the number to process a page or segment faster. It also may increase the amount of memory allocated to the RIP as faster processing consumes more memory. If processing is to be slower, such as for estimate 114 or preview 116, then the configured RIP should consume less memory. RIP manager 302 manages these requirements through dynamic configuration of the RIPs based on the parameter of job 103.

In some instances, RIP manager 302 may determine that job 103 is not able to be split into pages or segments for parallel processing. Thus, it may configure a RIP instance, such as RIP instance 308n, into a very high performance RIP. The very high performance RIP uses more renderers than the high performance RIP. For example, RIP instances 308n may be configured to use 8 renderers. This feature increases the processing speed of RIP instance 308n. Front end 302 may still use RIP instances 3081 and 3082 for parallel processing on one job 103 while using RIP instance 308n for processing another job 103 that is not able to be broken into pages or segments.

RIP system 110 provides features available due to the parallel processing using dynamically configured RIP instances. RIP system 110 may configure a high performance RIP to improve the first page out time. It also may use differently configured RIPs for different purposes, such a preview RIPs, estimation RIPs, and failover RIPs. RIP system 110 also may configure very high performance RIPs for jobs that cannot be processed in a page or segment parallel manner.

RIP system 110 also provides the ability to change the number of renderers per RIP. RIP system 110 also changes the number of RIP instances based on its workload, which includes shutting down certain types of RIPs in order to launch other types of RIPs. RIP system 100 also processes different kinds of jobs in RIPs with different configurations. RIP system 110 also uses different RIPs with different configurations for different purposes. It configures RIP instances with different imaging pipelines. RIP system 110 also retries failed jobs or job pages in a differently configured RIP instance.

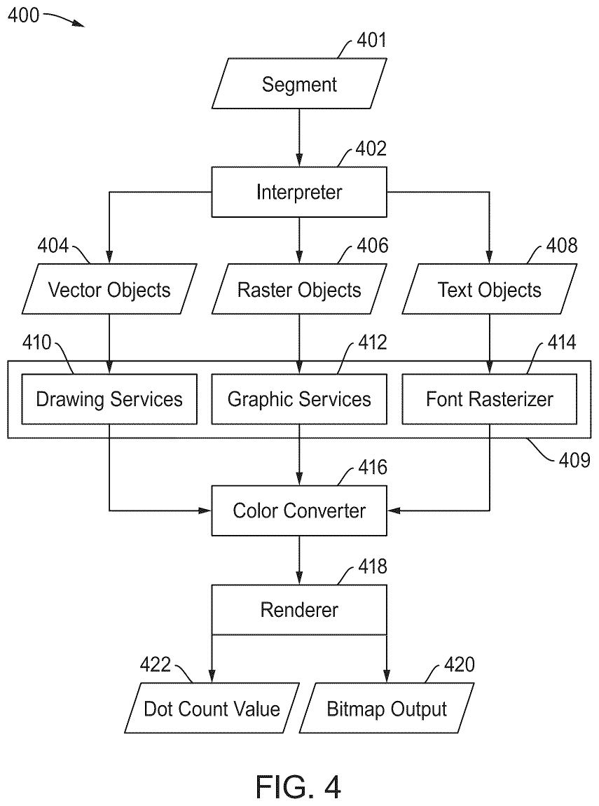

FIG. 4 depicts a block diagram of an example RIP 400 used within RIP system 110 according to the disclosed embodiments. RIP 400 may represent a configuration for RIP instances 3081, 3082, or 308n. RIP 400 may represent the hardware and software configuration used to determine what value each pixel or spot of output should possess, driven by commands from a page description language (PDL). Computer-generated output may be composed of very small spots. RIP 400 converts a vector-based image, or a stored image, into a series of mathematical formulas that describe lines and curves into a pattern of spots needed to generate the output, or raster image. Interpreter 402 converts a job file into a display list, which is then converted into a bitmap output 418 describing a page of the document.

RIP 400 converts text and image data from different file formats including PDF, TIFF, or JPEG into a format that printing device 104 can understand. The process of raster image processing a page implements several steps to be performed, regardless whether the page is submitted as PostScript, PDF, or any other page description language (PDL). In short, RIP 400 may provide interpretation, rasterization, and screening.

Segment 401 may be a job file associated with job 103. Segment 401 may be provided to RIP 400 to convert its code into raster or bitmap code. As disclosed above, front end 302 receives job 103. Front end 302 may split job 103 into segments for parallel processing by the RIP instances. Preferably, segment 401 is a page the document in job 103. RIPs process pages in a parallel manner within RIP system 100. RIP 400 is one of the RIP instances. In other embodiments, segment 401 may be several pages, a graphic design, or other portion of job 103.

Segment 401 is received at interpreter 402, which interprets the commands in the code to redraw the object and elements of a page as vector objects 404, raster objects 406, and text objects 408. Interpreter 402 parses specific PDLs into drawing commands. The PDL of segment 401 is read and decoded into graphical elements to be placed on a sheet. Each element may be an image, a character of text, a fill, stroke, and the like or listed in vector objects 404, raster objects 406, and text objects 408.

Drawing unit 409 receives vector objects 404, raster objects 406, and text objects 408 to convert the drawing commands into metadata that can be provided to renderer 418. Thus, drawing unit 409 converts vector objects 404 into drawing services 410. It also converts raster objects 406 into graphic services 412. It also converts text objects into font rasterizer 414.

RIP 400 also may implement color converter 416. Color converter 416 may implement color conversion operations for the metadata generated by drawing unit 409. Color converter 416 provides color management and calibration. These actions may be applied during interpretation or rendering, depending on configuration and job content. Color printing resources may be accessed to provide the color management.

Renderer 418 processes the metadata from drawing unit 409 to convert every graphical element into the appropriate pattern of pixels to form the output raster. The resolution independent vector objects 404 as drawing services 410 are converted into pixels. Screening takes the raster image of pixels to form individually screened cyan, magenta, yellow, and black separations. These are halftone dots in the form of a bitmap output 420 consisting of commands that can be understood by print engine 260.

The disclosed embodiments also may determine dot count value 422 from the rendered image provided by renderer 418. Dot count values may be adjusted based on screening and based on settings at printing device 104. Dot count value 422 may be reported to determine estimate 114 for an estimation job, as disclosed below.

The rendered bitmap output 420 may be stored in storage 306 to be sent to print engine 260 when all the pages or segments of job 103 are processed. RIP 400 shows one path for rendering and providing output. Preferably, RIP 400 multiple rendering paths that use multiple renderers. The disclosed embodiments may use a renderer 418 for each channel in RIP 400, such as one each for cyan, magenta, yellow, and black. The number of renderers 418 may be configured by front end 302 depending on job 103. Each renderer 418 requires memory and processing resources. A high number of renderers 418 in RIP 400 will consume more memory but run faster. A lower number of renderers 418 in RIP 400 will consume less memory but run slower.

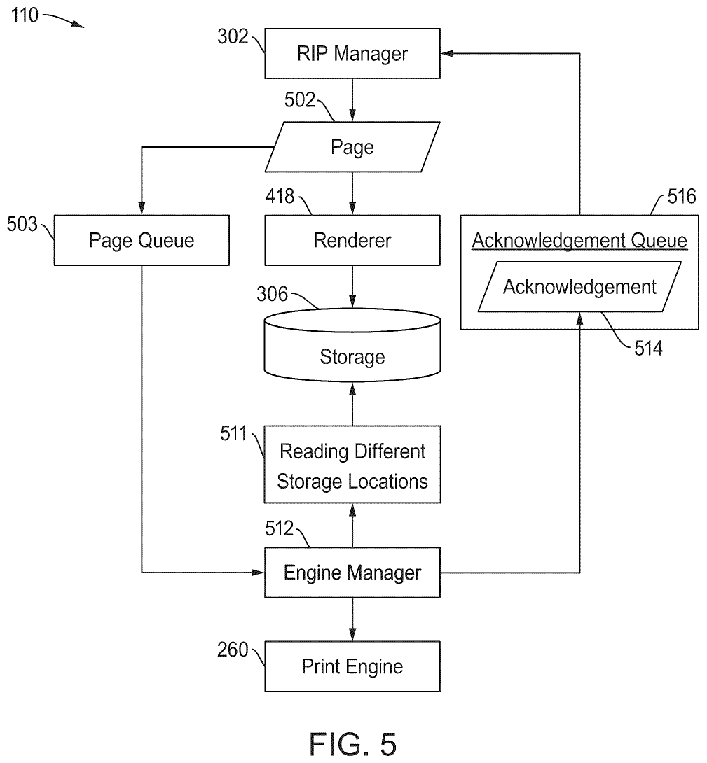

FIG. 5 depicts another block diagram of a RIP system 110 for use in managing printing operations according to the disclosed embodiments. FIG. 5 may disclose additional components of RIP system 110. For example, RIP system 110 includes RIP manager 302 and renderer 418, disclosed above. Further, RIP system 110 may include an engine manager 512, disclosed in greater detail below. RIP manager 302 may consider one or more pages 502 for print job 103. RIP manager 302 may determine if page 502 has already been rendered. If so, then the page data for the rendered page is placed into page queue 503. If page 502 has not been rendered, then it is passed to renderer 418.

Renderer 418 renders each page of a print job, as disclosed above. Renderer 418 then writes the rendered page to storage 306. Additional storages may be used if storage 306 becomes too full. In some embodiments, the rendered pages may be saved to specific storage locations within storage 306. These locations are provided to RIP manager 302 from renderer 418. RIP manager 302 provides these locations to engine manager 512 along with information regarding those pages within page queue 503. Engine manager 512 reads different storage locations based on the page data from page queue 503 according to operation 511 to retrieve the whole document and provide it to print engine 260 for printing. Engine manager 512 may be the interface between RIP system 110 and print engine 260. Pages may be printed in order as they are retrieved from their respective storage locations and provided to print engine 260.

After printing, the rendered page data is deleted from storage 306. Print manager 512 also may send an acknowledgement 514 to RIP manager 302, which then may delete the rendered page data from storage 306. Alternatively, engine manager 512 may delete the rendered page data from storage 306. In some embodiments, RIP system 110 may include an acknowledgement queue 516 to holds acknowledgement 514 to provide to RIP manager 302.

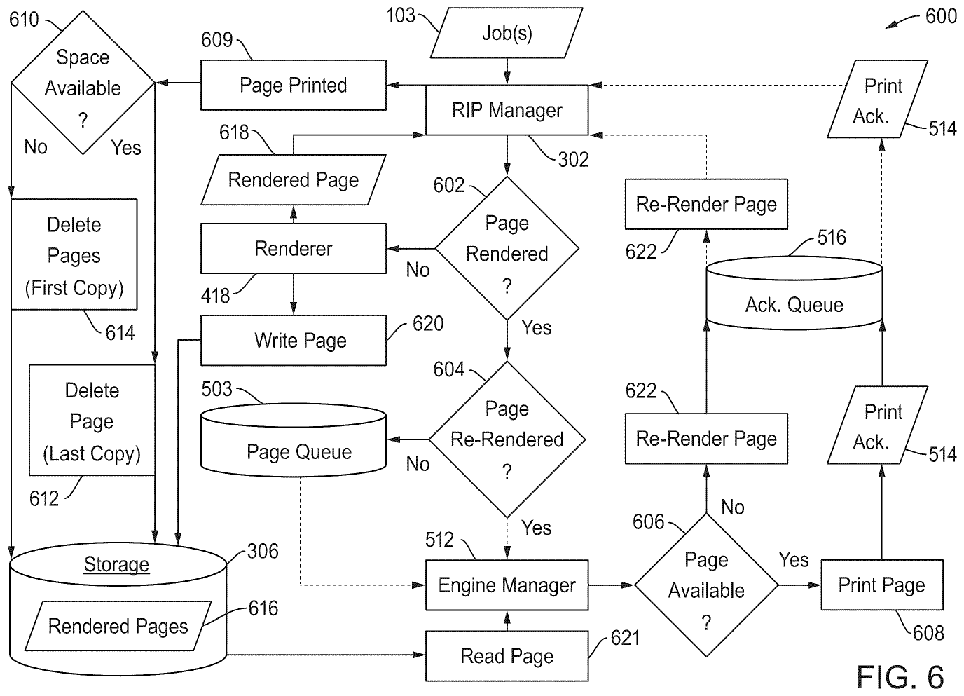

FIG. 6 depicts a flow diagram 600 for managing printing operations during out of sequence rendering process according to the disclosed embodiments. Flow diagram 600 may refer to FIGS. 1-5 for illustrative purposes. Flow diagram 600, however, is not limited to the embodiments disclosed by FIGS. 1-5.

The operations of printing collated copies for a job may require pages of the job to be rendered once, but printed multiple times. The rendered pages of a job only may be deleted after the last copy of the page is printed. The disclosed embodiments provide a use case for out of sequence rendering, where printed pages are deleted when a copy of the job is printed for a collated job. In flow diagram 600, pages are deleted after the first copy of the job is printed and when the critical space threshold is reached. Multiple printed pages may be deleted using various strategies. When engine manager 512 does not find a page in rendered pages 616 in storage 306, it calls RIP manager 302 to re-render the page. After re-rendering is completed, the page is made available to engine manager 512 and is printed.

This approach also may be used for a “proof and hold” job. A proof and hold job is received at printing device 104 and provided to RIP manager 302 of RIP system 110. A proof and hold job may correspond to print job 103 disclosed above, but the proof and hold term is used here as it describes the type of job. A proof and hold job is the type of job that is rendered, but only one copy of the job is printed. The printed copy is used to “proof” the job so that changes may be made, if needed, before the rest of the copies are printed. The remaining copies are printed on operator demand.

Thus, print job 103, or a proof and hold job, is received at RIP manager 302 for rendering and printing using RIP system 110. The job may be broken into pages, such as page 502, where each page includes its own data to be rendered for printing operations. Operation 602 executes by determining whether the page has been rendered previously. If yes, then flow diagram 600 proceeds to operation 604. If no, then flow diagram 600 proceeds to provide the page to renderer 418 for rendering operations.

Operation 604 executes by determining whether the page is re-rendered. If yes, then RIP manager 302 may provide the re-rendered page directly to engine manager 512 to provide the page to print engine 260. In other words, RIP system 110 has re-rendered the page to be printed using an out of sequence rendering process. A page being “re-rendered” may be a condition that determines whether the page is rendered for the first time, or was previously deleted and is being re-rendered for a second or more subsequent times. If a page is re-rendered, it is not queued in page queue 503 because engine manager 512 requires the page immediately and is waiting to provide the page to print engine 260. The re-rendered page is sent directly to engine manager 512 during out of sequence rendering.

If operation 604 is no, then the page is provided to page queue 503 to await retrieval by print manager 512, as done during normal printing operations. Thus, a page may already be rendered when provided to RIP manager 302 but not subject to an out of sequence rendering process, or, in other words, is not re-rendered. The rendered page is placed into page queue 503.

Operation 606 executes by determining whether the page is available in either rendered pages 616 in storage 306 or page queue 503. Engine manager 512 may execute a read page instruction 621 to retrieve the page to be printed. Further, it may receive a re-rendered page from operation 604. If the page is available, then operation 606 proceeds to operation 608 to print the page by provided the data for the rendered page to print engine 260. Engine manager 512 may send the rendered page data to print engine 260.

A print acknowledgment 514 is provided to acknowledgement queue 512 and then to RIP manager 302 after completion of operation 608. RIP manager 302 may generate a page printed instruction 609 and executes operation 610 to determine whether space is available on storage 306. In other words, RIP manager 302 or RIP system 110 may determine whether a storage threshold for storing data has been reached in storage 306 by rendered pages 616.

For example, the storage threshold may be 80%, or the threshold is reached when 80% or more of the data storage is taken. In other words, only 20% or less of the space is available to store more rendered pages 616. If the data storage for storage 306 is above the threshold, then certain actions need to be taken. The disclosed embodiments may determine that only specific pages will be stored at storage 306 as the space is needed for other print job processing operations.

Thus, if operation 610 is yes, then the printed page is deleted after the last copy is printed, as disclosed by instruction 612. If operation 608 printed the page for the last copy of the plurality of copies for the job, then it is deleted from storage 306. Otherwise, the page is not deleted and printing operations proceed to the next page for printing.

If operation 606 is no and adequate space is not available in storage 306, then the page is deleted after the first copy is printed. Storage 306 cannot accept more rendered pages 616. The page is not stored as a rendered page and not available to engine manager 512 to printing with subsequent copies. Thus, the page will need to re-rendered.

Referring back to operation 602, if the page has not been rendered, then the determination is no. Renderer 418 is assigned to render the page, as disclosed above. After rendering operations, renderer 418 may perform operation 620 by writing the page to storage 306. It also may provide rendered page 618 if it was assigned to re-render the page, as disclosed below.

Referring back to operation 606, if the page is not available to engine manager 512 from page queue 503 or storage 306, then an out of sequence rendering process is executed. In some embodiments, engine manager 512 will generate a re-render page instruction 622 to RIP manager 302. The re-render page instruction, or request, may be held in acknowledgement queue 512 until read by RIP manager 302. Upon receipt of instruction 622, RIP manager 302 instructs assigns renderer 418 to render the page via operation 602. If renderer 418 is currently assigned to another job, the RIP manager 302 may take renderer away from that job and reassign it to render the page out of sequence from print job 103. Renderer 418 provides the rerendered page 618 to RIP manager 302. RIP manager 302 may provide the re-rendered page directly to engine manager 512 to perform operation 608 of printing the page.

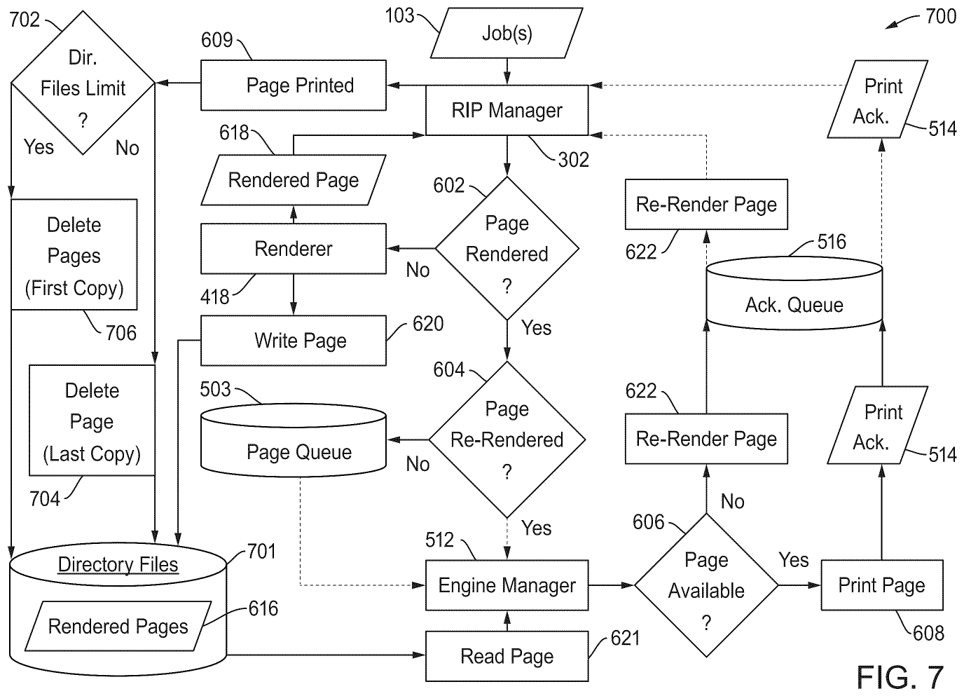

FIG. 7 depicts another flow diagram 700 for managing printing operations during out of sequence rendering process according to the disclosed embodiments. Flow diagram 700 may refer to FIGS. 1-6 for illustrative purposes. Flow diagram 700, however, is not limited to the embodiments disclosed by FIGS. 1-6.

Flow diagram 700 may disclose the use case for an out of sequence rendering process where a page is deleted when the first copy of the job is printed for a collated job. According to flow diagram 700, pages are deleted after the first copy of the job is printed, when a directory files threshold limit for directory files 701 is reached. When engine manager 512 does not find a page in directory files 701, it calls RIP manager 302 to re-render the page. After re-rendering is complete, the page is made available to engine manager 512 and is printed.

Flow diagram 700 includes features disclosed within flow diagram 600. Those features may not be repeated here for brevity. In short, flow diagram 700 determines whether a page has been rendered. If not, then renderer 418 renders the page. If yes, then flow diagram 700 determines whether the page was re-rendered according to RIP manager 302 in response to a re-render page instruction 622 from engine manager 512. If so, then the re-rendered page is provided directly to engine manager 512 for printing. If not, then the rendered page may be placed in page queue 503. In other embodiments, renderer 418 writes the page to an entry in directory files 701.

A directory file threshold limit may be reached while printing a long job. There may be restrictions on the number of entries that can be stored in a directory for different file allocation tables. If the number of entries exceed that restriction, then a failure occurs. Entries may need to be deleted to not exceed the directory file threshold limit. For example, directory files 701 may include 40,000 entries, one for each rendered page. The files may include different identification number of names.

The threshold may be 80% of the number of entries for directory files 701, or 32,000 entries. If 32,000 pages have been stored in entries for directory files 701, then the disclosed embodiments may determine no further pages may be stored. When the number of entries having pages reaches this threshold, additionally rendered pages may not be stored in directory files 701. Thus, they may be deleted. Referring to operation 702, it determines whether the number of entries for rendered pages 610 in directory files 701 exceeds the threshold limit. If no, then delete page operation 704 executes by deleting the page if the recently printed copy is the last copy for print job 103.

If operation 702 is yes, then the directory threshold limit is reached and further pages may not be placed in entries of directory files 701. Thus, the page is deleted after printing the first copy of the print job. RIP system 110 continues to rendered subsequent pages without saving them to retrieval by engine manager 512. The pages have been printed and will be rendered again using the out of sequence rendering process disclosed above. Except this process indicates that the page is not available in directory files 701 or page queue 503. RIP manager 302 will reassign renderer 418 from a current job to re-render the page. Once rendered page 618 is received at RIP manager 302, it is provided to engine manager 512 to print with the current copy of the print job so as to not hold up printing operations.

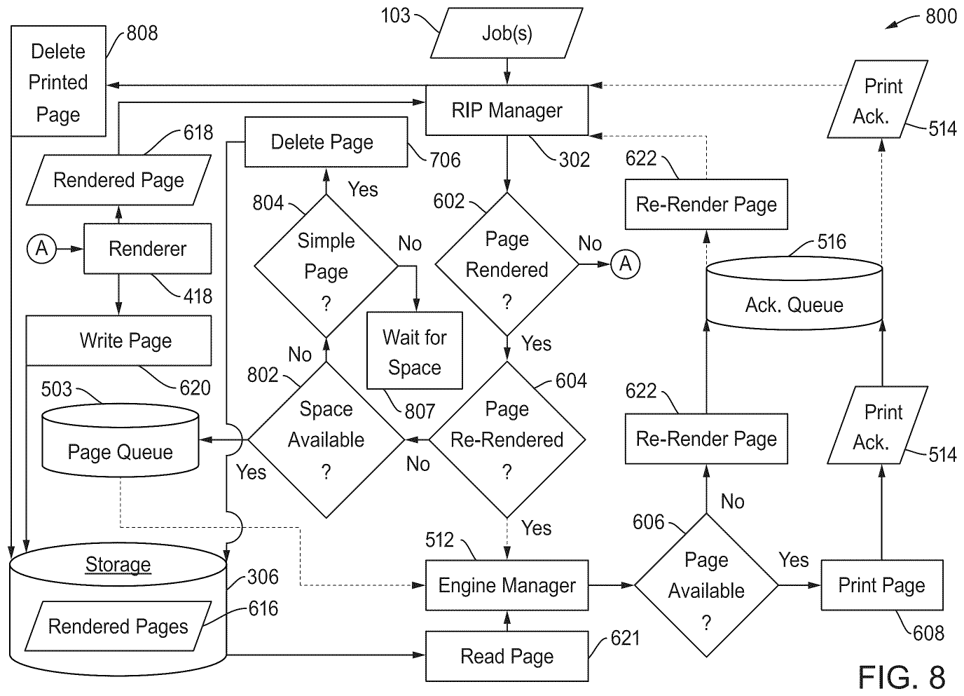

FIG. 8 depicts another flow diagram 800 for managing printing operations according to the disclosed embodiments. Flow diagram 800 may refer to FIGS. 1-7 for illustrative purposes. Flow diagram 800, however, is not limited to the embodiments disclosed by FIGS. 1-7.

Flow diagram 800 discloses the use case for an out of sequence rendering process where simple pages are deleted. This situation may happen for a long job where the rendered pages are ahead by thousands of pages, or more than print engine 260 can print. In flow diagram 800, RIP manager 302 calls renderer 418 to render a page. If the rendered page is a simple page and the critical space threshold is reached, the page is deleted from storage 306, as disclosed above. The page information may still be queued to engine manager 512.

When engine manager 512 does not find the page in storage 306 or page queue 503, it calls RIP manager 302 to re-render the page, as disclosed above. After the re-rendering is done by renderer 418, the page is made available to engine manager 512 and is printed. In some embodiments, this process helps in rendering of complex pages ahead of time to ensure that print engine 260 is not stalled while waiting for a complex page to be re-rendered. Flow diagram 800 includes features disclosed within flow diagrams 600 and 700. Those features may not be repeated here for brevity.

After operation 604, if it is determined that the page is not re-rendered as instructed by RIP manager 302, then operation 802 executes by determining whether space is available in storage 306. In other words, operation 802 determines if the critical space threshold is reached, as disclosed above. If space is available, then the page may be placed in page queue 503 to wait for retrieval by engine manager 512. Rendered page 618 does not need to be deleted from rendered pages 616 of storage 306.

If operation 802 is no, then operation 804 executes by determining whether rendered page 618 is a simple page. In other words, the disclosed embodiments may determine whether rendered page 618 is a complex page. According to the disclosed embodiments, a complex page may be a page in a document that is rendered slower than the engine speed of print engine 260. Engine speed refers to the printing speed of print engine 260 after it receives a rendered page from engine manager 512.

A non-complex page may be known as a simple page. The rendering of simple pages may occur at faster pace than the engine speed of print engine 260. Rendered simple pages may fill up the limited storage space, or space complexity of memory 306. An out of sequence rendering process for a simple page may be performed fairly quickly without tying up resources of RIP system 110.

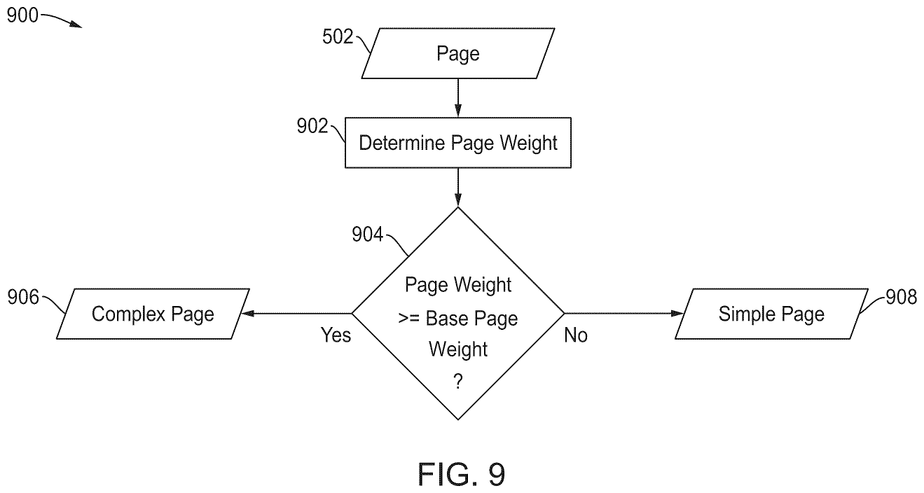

FIG. 9 depicts a flow diagram 900 for page complexity determination in RIP system 110 according to the disclosed embodiments. Flow diagram 900 may refer to FIGS. 1-8 for illustrative purposes. Flow diagram 900, however, may not be limited to the embodiments disclosed by FIGS. 1-8. Flow diagram 900 may be implemented in RIP system 110. For example, flow diagram 900 may be implemented by RIP manager 302 or renderer 418. In other embodiments, flow diagram 900 may be implemented elsewhere within printing system 100, such as controller 106.

Page 502 is received at RIP system 110 have renderer 418. Page 502 may be part of job 103. According to the disclosed embodiments, it is determined that the storage location for rendered pages of the job is not available or is limited so that the entire data set for the rendered pages cannot be stored. The disclosed embodiments determine if page 502 is complex. Operation 902 executes by determining a page weight for page 502. This process is disclosed in greater detail below and is based on a set of rules and a weighted formula. Operation 904 executes by determining whether the page weight is greater than or equal to a base page weight. The base page weight is disclosed in greater detail below and is determined based on the engine speed of print engine 260. Thus, determining whether a page is complex relates to whether the page can be rendered “at speed” during printing operations.

If operation 904 is yes, then page 502 is marked as a complex page in operation 906. If operation 904 is no, then page 502 is marked as a simple page in operation 908. The simple page may be re-rendered using the out of sequence rendering process disclosed above.

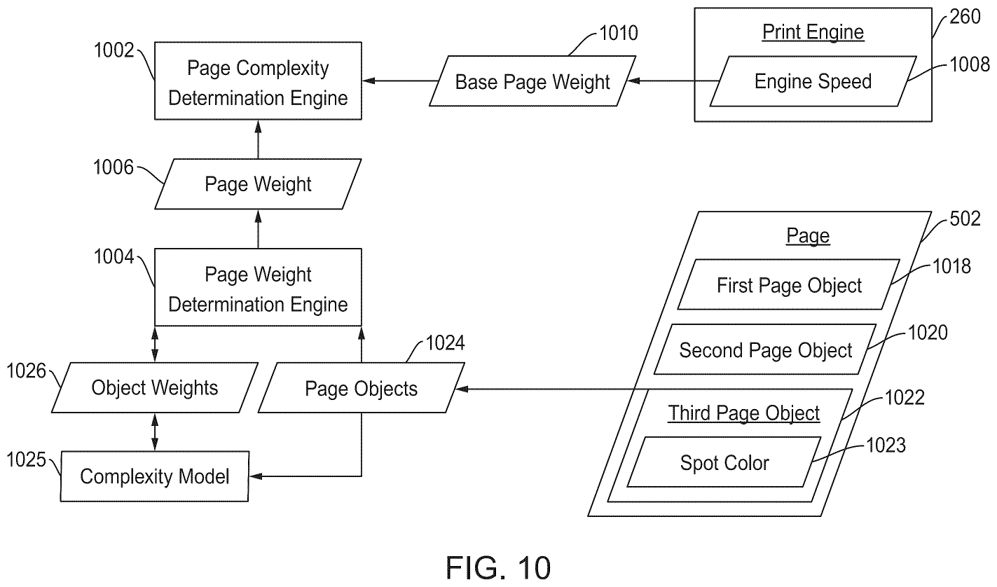

FIG. 10 depicts a block diagram of the components used for page complexity determination according to the disclosed embodiments. As disclosed above, base page weight 1010 and page weight 1006 are determined to be used in deciding whether page 502 is complex or simple. Both of these values are calculated using information available from printing device 104 and objects within page 502. These features are disclosed in greater detail below.

Base page weight 1010 relates to engine speed 1008 of print engine 260 of printing device 104. Engine speed 1008 may refer to the pages or sheet per minute that printing engine 260 can process, or put ink to paper. This speed may refer to an average speed for a number of previous print jobs, or to the speed to print a page having no objects, such as one with only text. The disclosed embodiments may assign a weight, or value, to engine speed 1008.

For example, print engine 260 may have an engine speed 1008 of 150 PPM. This value may be based off previous print jobs and their engine speed to print pages of those jobs, regardless of the content on those pages. Alternatively, the disclosed embodiments may take the engine speed of printing certain types of pages, such as text only, pages with objects, pages with color printing, and the like. Using this example, base page weight 1010 for engine speed 1008 of 150 PPM may be 10.0.

For determining page weight 1006, a page weight determination engine 1004 may be implemented within renderer 418 of a RIP within RIP system 110. Page weight determination engine 1004 also may be implemented elsewhere in controller 106, print management server 108, or RIP system 110. Page weight determination engine 1004 may take into account page objects 1024 from page 502 and object weights 1026. These features are disclosed separately below.

Page objects 1024 are objects, such as images, graphics, text, and the like, within page 502. For example, page 502 may include first page object 1018, second page object 1020, and third page object 1022. Third page object 1022 may include a spot color 1023 that is required to print the third page object accurately. As disclosed above, an object may have a type, such as vector, text, or image. Objects may be further classified into operators, such as form, shading, group, Type 3 characters, pattern, font, color space, spot color, and the like. For example, first page object 1018 may be a vector object having shading as an operator, second page object 1020 may be a text object having a specific font and several Type 3 characters as operators, and third page object 1022 may be an image object having spot color 1023 as an operator.

The disclosed embodiments may compile the page objects and their operators into page objects 1024 for page 502. Page objects 1024 are provided to page weight determination engine 1004. Page weight determination engine 1004 may use one or more weighted formulas to determine the weights for page objects 1024. The weighted formulas may rely on object weights 1026 provide from complexity model 1025. The disclosed embodiments gather statistics and generates complexity model 1025 based on these determinations. Complexity model 1025 is based on various components of a page, such as the type of objects disclosed above, or vector, text, or image. The objects in complexity model 1025 also may be further classified into operators.

When page weight determination engine 1004 receives page objects 1024 of page 502, it may retrieve object weights from complexity model 1025. Alternatively, page objects 1024 may be provided to complexity model 1025, which then provides page object 1024 along with object weights 1026 to page weight determination engine 1004. First page object 1018 may be compared to a similar page object in complexity model 1025 to obtain a weight for the first page object. Second page object 1020 may compared to a similar page object in complexity model 1025 to obtain a weight for the second page object. Third page object 1022 may be compared to a similar page object in complexity model 1025 to obtain a weight for the third page object. In some embodiments, the object weights for first page object 1018, second page object 1020, and third page object 1022 may be added together to determine page weight 1006.

Page complexity determination engine 1002 applies the rule that a page is marked complex if page weight 1006 exceeds base page weight 1010. If page weight 1006 exceeds base page weight 1010, then page 502 is marked complex. If page weight 1006 is equal or less than base page weight 1010, then page 502 is marked as simple. Referring to the embodiments disclosed above, a complex page is stored in the storage location while a simple page may be discarded.

Referring back to flow diagram 800, if operation 804 determines the page is a simple page, then operation 806 executes by deleting the page from storage 306. RIP manager 302 may instruct storage 306 to delete the page or renderer 418 to delete the page. Thus, engine manager 512 will need to instruct RIP manager 302 to re-render the page when it is to be printed with a subsequent copy of print job 103. In other words, the out of sequence rendering process may be performed by assigning renderer 418 to re-render the page. If operation 804 is no, then operation 807 executes by waiting for space to become to store the page. The page is determined to be a complex page. The complex page should be stored when space becomes available for later retrieval. It will be made available to engine manager 512 for subsequent copies of the print job without the need to re-render the page.

In some embodiments, RIP manager 302 may execute operation 808 to delete a printed page after receipt of print acknowledgement 514. If the printed page is determined to be a simple page, then engine manager 512 may inform RIP manager 302 that the printed page may be deleted from storage 306, even if enough space is available as the page may be re-rendered in a manner that does not tie up printing operations. If operation 808 is executed, then engine manager 512 may perform an out of sequence rendering process to obtain the rendered page by sending re-render page instruction 622.

In some embodiments, the page information may still be queued in page queue 503 to be provided to engine manager 512. The page queued without a condition may indicate that a page record, or information, is being queued no matter if the page is simple or complex. No rendered page data is being stored. The page record informs engine manager 512 of the location within RIP system 110 where the rendered page data is stored. Engine manager 512 tries to read the rendered page data from that storage location. If it cannot read the data, or the page record does not provide a location as the page is deleted, then engine manager 512 may inform RIP manager 302 to re-render the page. This feature of the disclosed embodiments may apply to flow diagrams 600 and 700 as well as flow diagram 800.

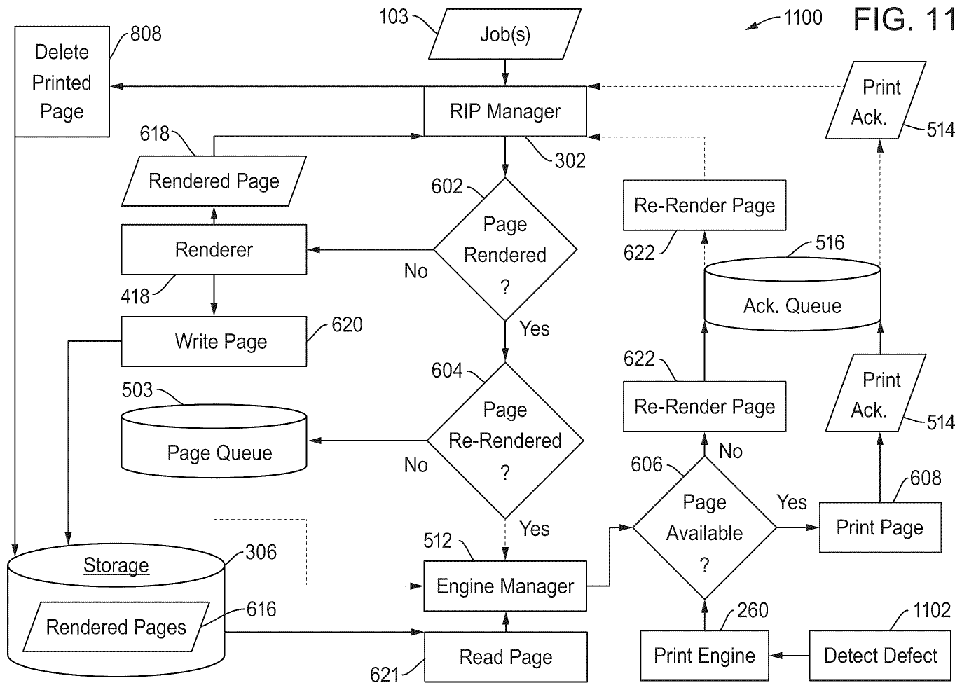

FIG. 11 depicts another flow diagram 1100 for managing printing operations (defect detection) according to the disclosed embodiments. Flow diagram 1100 may refer to FIGS. 1-10 for illustrative purposes. Flow diagram 1100, however, is not limited by the embodiments disclosed by FIGS. 1-10.

Flow diagram 1100 discloses the use case for an out of sequence rendering process when a defect is detected on the printed page or pages. The page might already be deleted when the defect is detected. Thus, print engine 260 requests the page to re-rendered. This issue may be an abnormal condition that occurs in normal print flow, which requires a page to be re-rendered. Flow diagram 1100 includes features disclosed within flow diagrams 600, 700, and 800. Those features may not be repeated here for brevity.

A page may be rendered and printed as normal. Upon receipt of print acknowledgement 514, RIP manager 302 may perform operation 808 by deleting the printed page from storage 306. During review of the printed page, however, operation 1102 may execute by detecting a defect on the printed page. For example, a white line may be detected. The detection may be made within printing device 104 so that print engine 260 is informed of the defect. Print engine 260 then may attempt to reprint the page without the defect. Thus, operation 606 is executed to determine if the page is available to be printed.

If operation 606 is yes, then print engine 260 can execute operation 608 by printing page. If operation 606 is no, then print engine 260 may instruct engine manager 512 to send re-render page instruction 622 to RIP manager 302. Alternatively, print engine 302 may send an instruction to re-render the defective page. RIP manager 302 may note that it instructed storage 306 to delete the printed page according to operation 808. Thus, RIP manager 302 reassigns renderer 418 to perform the out of sequence rendering process to re-render the page and provide it to print manager 512 to printing. If renderer 418 is processing another print job, RIP manager 302 may pull it from that job and have it render the defective page so that printing operations may resume at print engine 260.

It should be noted that printing device 104 may detect the defect and automatically request that RIP system 110 re-render the page. Alternatively, the operator may determine a defect and ask printing device 104 to reprint. Printing device 104 may request that print engine 260 reprint the page, which invokes the out of sequence rendering process.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing printing operations, the method comprising:
processing a print job at a raster image processing (RIP) system corresponding to a printing device, wherein the print job includes at least one page;
rendering a page of the at least one page for the print job using the RIP system;
printing the page at the printing device;
deleting the page from a storage associated with the RIP system;
detecting an error on the page as printed;
detecting that the page is not available within the storage for reprinting;
instructing a RIP manager of the RIP system to render the page;
assigning a RIP of the RIP system to the page; and
rendering the page at the assigned RIP for reprinting.

2. The method of claim 1, further comprising wherein detecting that the page is not available includes using an engine manager within the RIP system to interact with the RIP manager.

3. The method of claim 2, wherein instructing the RIP manager includes sending an instruction from the engine manager to the RIP manager.

4. The method of claim 2, wherein the engine manager exchanges data with a print engine of the printing device.

5. The method of claim 1, wherein the error includes a defect on the page as printed.

6. The method of claim 1, wherein assigning the RIP includes stopping rendering operations at the RIP for another page.

7. The method of claim 6, further comprising determining that at least one RIPs within the RIP system are busy.

8. The method of claim 1, further comprising reprinting the page at the printing device.

9. A method for managing printing operations, the method comprising:
processing a print job at a raster image processing (RIP) system corresponding to a printing device, wherein the print job includes a plurality of copies of a document having at least one page;
rendering a page of a first copy of the plurality of copies using the RIP system;
detecting that the page from the first copy is not available for printing a subsequent copy of the document;
instructing a RIP manager of the RIP system to render the page;
assigning a RIP to the page; and
rendering the page at the assigned RIP to print with the subsequent copy.

10. The method of claim 9, further comprising deleting the page after the first copy is printed at the printing device.

11. The method of claim 10, wherein deleting the page includes deleting the page from a storage accessible by the RIP system.

12. The method of claim 9, further comprising storing the page of the first copy after rendering to a storage.

13. The method of claim 12, further comprising determining that a storage threshold for the storage is reached.

14. The method of claim 13, further comprising deleting the page from the storage after the first copy is printed.

15. The method of claim 9, wherein detecting that the page is not available includes using an engine manager within the RIP system.

16. The method of claim 15, wherein instructing the RIP manager includes sending an instruction from the engine manager to the RIP manager.

17. The method of claim 15, wherein the engine manager exchanges data with a print engine of the printing device.

18. A printing device comprising:
a print engine to perform printing operations; and
a digital front end (DFE) having a processor and a memory, wherein the DFE manages the printing operations in conjunction with the print engine,
wherein the memory stores instructions that, when executed on the processor, configures the processor to perform the operations of
processing a print job at a raster image processing (RIP) system corresponding to the DFE, wherein the print job includes a plurality of copies of a document having at least one page;
rendering a page of a first copy of the plurality of copies using the RIP system;
detecting that the page from the first copy is not available for printing a subsequent copy of the document;
instructing a RIP manager of the RIP system to render the page;
assigning a RIP to the page; and
rendering the page at the assigned RIP to print with the subsequent copy.

19. The printing device of claim 18, wherein the instructions further configure the processor to perform the operations of deleting the page after the first copy is printed at the printing device.

20. The printing device of claim 18, wherein the DFE includes a storage, wherein the page is stored in the storage.
